(19) United States
(12) Patent Application Publication
(10) Pub. No.: US 2004/0214467 A1
(43) Pub. Date: Oct. 28, 2004

(54) Electronic card connector

(76) Inventor: Hui Wen Tsao, Panchiao City (TW)

Correspondence Address: BIRCH STEWART KOLASCH & BIRCH, PO BOX 747, FALLS CHURCH, VA, 22040-0747, US

(21) Appl. No.: 10/421,863

(22) Filed: Apr. 24, 2003

(51) Int. Cl. H01R 13/62

(52) U.S. Cl. 439/328

(57) ABSTRACT

An electronic card connector formed of an electrically insulating housing and a set of terminals in the housing is described in which the housing has an insertion hole defined in the flat base thereof for receiving an electronic card and two parallel spring arms respectively and perpendicularly extended from two distal ends of the base for securing the inserted electronic card in position. Each spring arm has a protruding retaining block for holding down the inserted electronic card in the insertion slot of the housing and a supplementary retaining block for supporting the inserted electronic card in the insertion slot of the housing.

### BACKGROUND OF THE INVENTION

1. Field of the Invention

The present invention relates to an electronic card connector adapted to receive an electronic card and to electrically connect the electronic card to a circuit board. More particularly, the present invention relates to an electronic card connector that secures the electronic card in position after insertion of the same.

2. Description of the Related Art

An electronic card (IC card or smart card) is a mobile data storage device electrically connectable to the circuit board of an electronic apparatus, for example, a word processor, computer or the like, for enabling data stored therein to be transferred to the circuit board.

FIGS. 1-3 illustrate an electronic card connector constructed according to Taiwan Publication No. 456638, invented by the present inventor, for use in an electronic apparatus for receiving an electronic card. This structure of electronic card connector comprises an electrically insulating housing 1 and a set of terminals 2. The housing 1 comprises an elongated flat base 11, which has an insertion slot 111 and two parallel spring arms 12 respectively and perpendicularly extended from the distal ends of the base 11 in same direction. Each spring arm 12 has a protruding retaining block 13 at the inner side 121. The protruding retaining block 13 has a stepped retaining portion 131. The stepped retaining portion 131 has a relatively bigger upper part and a relatively smaller lower part. During installation of an electronic card 3, the electronic card 3 is obliquely inserted into the insertion slot 111 and then forced downwards into the engaged position between the spring arms 12 and retained in the inserted position by the stepped retaining portions 131 of the protruding retaining blocks 13 of the spring arms 12 (see FIGS. 2 and 3).

This structure of electronic card connector is not, however, satisfactory in function. Because the spring arms 12 engage only a limited area of each lateral side of the inserted electronic card 3, the inserted electronic card 3 tends to be forced out of the card connector 1 during a vibration or destruction test. Directly increasing the size of the protruding retaining blocks 13 of the spring arms 12 may improve the electronic card retaining effect but results in the difficult insertion of an electronic card.

Therefore, it is desirable to provide an electronic card connector that eliminates the aforesaid drawbacks.

### SUMMARY OF THE INVENTION

The present invention has been accomplished under the circumstances in view. It is therefore the main object of the present invention to provide an electronic card connector that facilitates the insertion of an electronic card. It is still another object of the present invention to provide an electronic card connector that secures the electronic card in position after insertion of the same.

To achieve these and other objects of the present invention, the card connector comprises an electrically insulating housing. The housing comprises an elongated flat base and two parallel spring arms respectively and perpendicularly extended from two distal ends of the base in one direction. The base has an insertion slot adapted to accommodate an electronic card. The spring arms-each have an inner side facing each other. A plurality of terminals is arranged in the insertion slot of the housing. A protruding retaining block is respectively provided on the inner side of each of the spring arm and is adapted to hold down an electronic card in the insertion slot of the housing. A supplementary retaining block is respectively provided on the inner side of each of the spring arm behind the protruding retaining block at the respective spring arm and is adapted to support an electronic card in the insertion slot of the housing.

### BRIEF DESCRIPTION OF THE DRAWINGS

The various objects and advantages of the present invention will be more readily understood from the following detailed description when read in conjunction with the appended drawing, in which:

FIG. 1 is an elevational view of a card connector according to the prior art;

FIG. 2 is a top view of a part of the card connector shown in FIG. 1;

FIG. 2A is an enlarged view of a part of FIG. 2;

FIG. 3 is a cross-sectional view taken along line 3-3 of FIG. 2;

FIG. 4 is an elevational view of a card connector according to the present invention;

FIG. 5 is a top view of a part of the card connector shown in FIG. 4;

FIG. 5A is an enlarged view of a part of FIG. 5; and

FIG. 6 is a cross-sectional view taken along line 6-6 of FIG. 5.

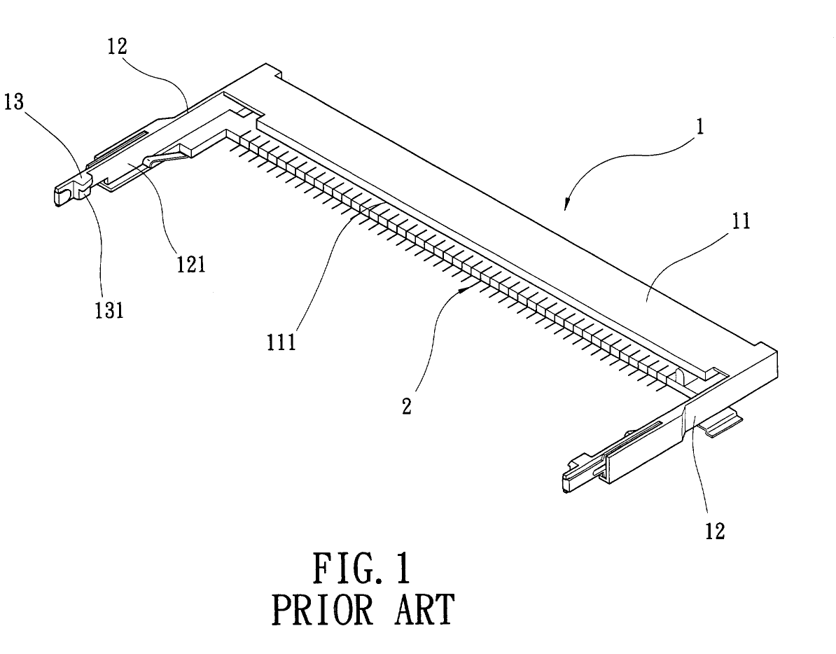

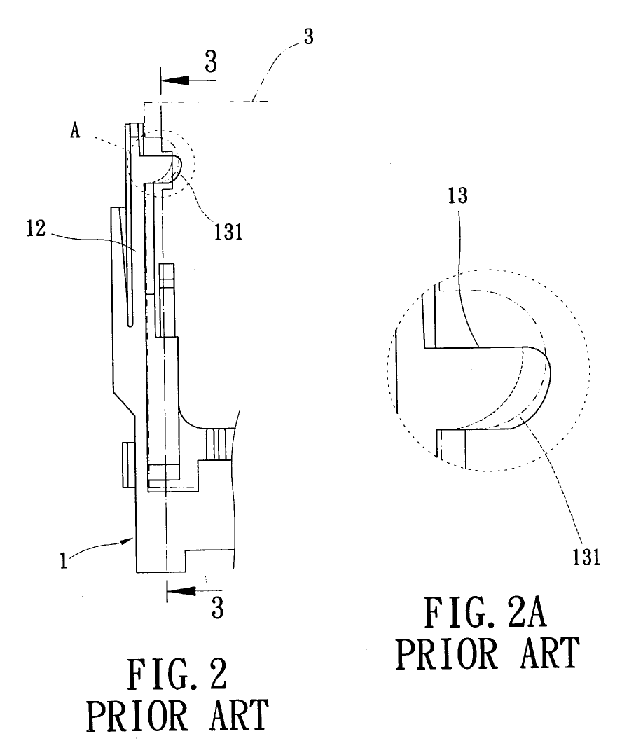

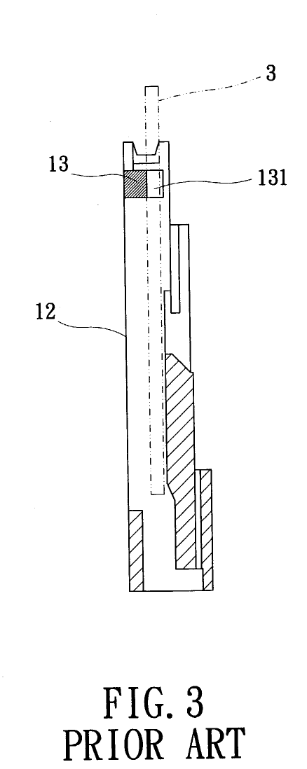

### DETAILED DESCRIPTION OF THE PREFERRED EMBODIMENT

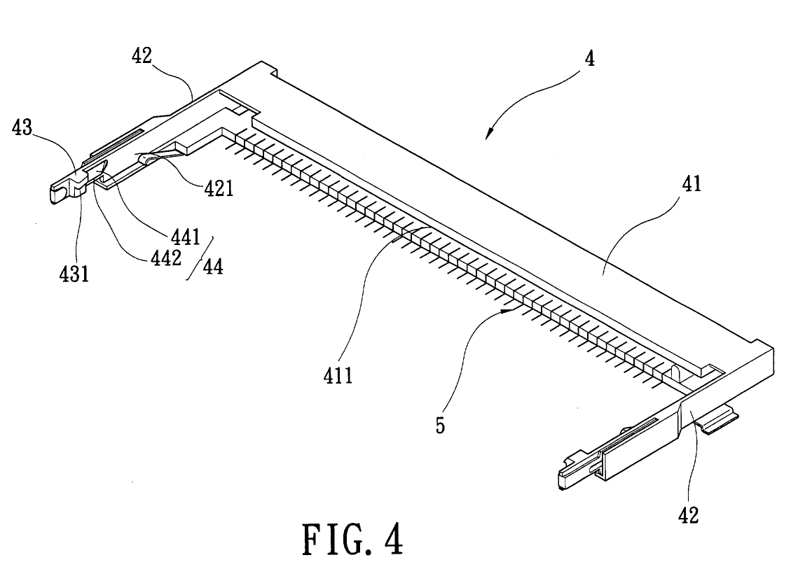

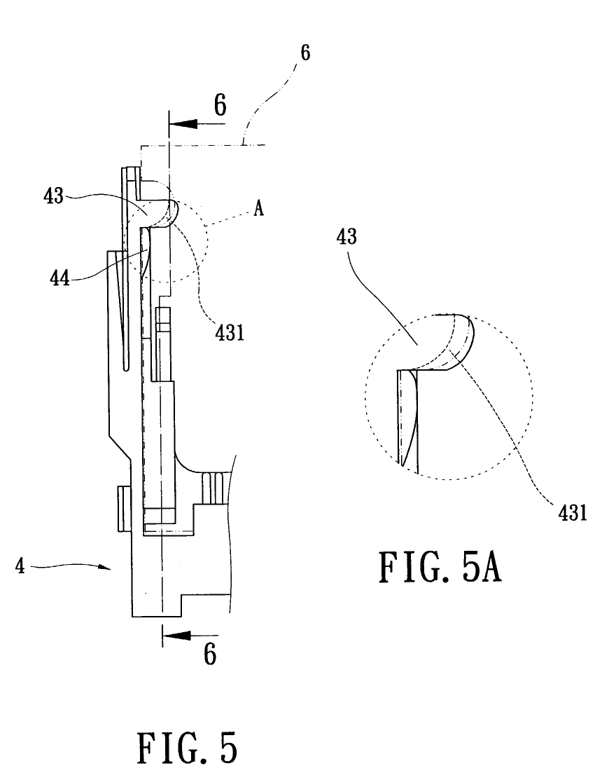

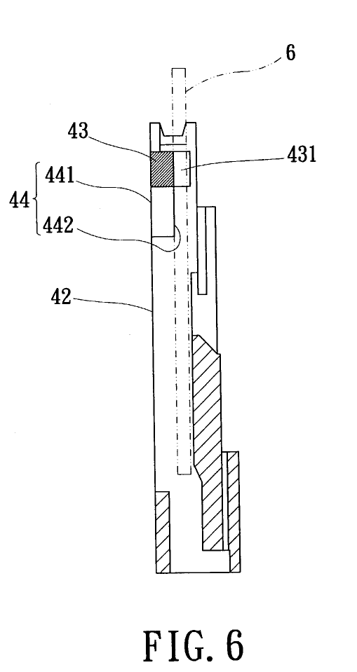

Referring to FIGS. 4-6, a card connector in accordance with the present invention is shown comprising an electrically insulating housing 4, and a set of terminals 5 installed in the housing 4. The housing 4 comprises an elongated flat base 41, and two parallel spring arms 412 respectively and perpendicularly extended from the distal ends of the base 41 in same direction. The base 41 has an insertion slot 411 adapted to accommodate an electronic card 6. Each spring arm 42 has a protruding retaining block 43 and a supplementary retaining block 44 at the inner side 421. The protruding retaining block 43 has a stepped retaining portion 431. The stepped retaining portion 431 has a relatively bigger upper part and a relatively smaller lower part. The supplementary retaining block 44 may be formed on the inner side 421 of the respective spring arm 42 and be separated from the respective protruding retaining block 43 by a distance. Alternatively, the supplementary retaining block 44 can be extended from one side of the protruding retaining block 43 toward the base 41. The supplementary retaining block 44 has a slope 441 formed in the relatively smaller upper part thereof and a flat bearing base 442 formed in the relatively bigger lower part thereof.

The supplementary retaining blocks 44 of the spring arms 42 increase the electronic card retaining area of the spring arms 42. During installation of an electronic card 6, the electronic card 6 is obliquely inserted into the insertion slot 411 and then forced downwards into the engaged position between the spring arms 42 and retained in the engaged position where the electronic card 6 is supported on the flat bearing base 442 of the supplementary retaining block 44 of each spring arm 42 and the bigger upper part of the stepped retaining portion 431 of the protruding retaining block 43 of each spring arm 42.

A prototype of card connector has been constructed with the features of the annexed drawings of FIGS. 4-6. The card connector functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A card connector comprising
an electrically insulating housing, said housing comprising
an elongated flat base, and two parallel spring arms respectively and perpendicularly extended from two distal ends of said base in one direction, said base having an insertion slot adapted to accommodate an electronic card, said spring arms each having an inner side facing each other;
a plurality of terminals arranged in said insertion slot of said housing;
a protruding retaining block respectively provided on the inner side of each of said spring arm and adapted to hold down an electronic card in said insertion slot of said housing; and
a supplementary retaining block respectively provided on the inner side of each of said spring arm behind the protruding retaining block at a respective spring arm and adapted to support an electronic card in said insertion slot of said housing.

2. The electronic card connector as claimed in claim 1, wherein said supplementary retaining block has a slope on an upper side and a flat bearing base on a bottom side.

3. The electronic card connector as claimed in claim 1, wherein said supplementary retaining block is separated from the protruding retaining block of the respective spring arm by a distance.

4. The electronic card connector as claimed in claim 1, wherein said supplementary retaining block is connected to the protruding retaining block of the respective spring arm.

5. The electronic card connector as claimed in claim 1, wherein said supplementary retaining block is formed integrally with the protruding retaining block of the respective spring arm.

6. The electronic card connector as claimed in claim 1, wherein said protruding retaining block has a stepped retaining portion, said stepped retaining portion having a relatively bigger upper part and a relatively smaller lower part.

7. The electronic card connector as claimed in claim 1, wherein said supplementary retaining block has a relatively smaller upper part and a relatively bigger lower part.

8. The electronic card connector as claimed in claim 7, wherein said supplementary retaining block has a slope on the relatively smaller upper part and a flat bearing base on the relatively bigger lower part.
